(19) United States
(12) Patent Application Publication
(10) Pub. No.: US 2011/0164417 A1
(43) Pub. Date: Jul. 7, 2011

(54) LAMP STRUCTURE

(76) Inventor: YING FANG HUANG, Taichung City (TW)

(21) Appl. No.: 12/683,400

(22) Filed: Jan. 6, 2010

(51) Int. Cl. F21V 1/00

(52) U.S. Cl. 362/235

(57) ABSTRACT

A lamp structure comprises an aluminum extrusion pipe, a light transmission cover, and a light emitting member. The aluminum extrusion pipe is axially provided with at least one first sidewall, one second sidewall and one opening, the first sidewall is formed with at least an engaging groove in communication with a through hole in the first sidewall, the second sidewall is provided with at a light reflection surface. The light transmission cover is mounted on the aluminum extrusion pipe to cover the opening. The light emitting member includes a flexible circuit board and plural light sources, the light sources are arranged spaced apart on the flexible circuit board, the light of the light sources of the light emitting member are focused on the light transmission cover through reflection by the light reflection surface, and finally projected out of the aluminum extrusion pipe after passing through the light transmission cover.

### BACKGROUND OF THE INVENTION

1. Field of the Invention

The present invention relates to a lamp structure, and more particularly to a low cost lamp structure which is flexible in shape, easy to assemble and can produce better illumination without light spots.

2. Description of the Prior Art

The housing of a conventional SMD (surface mount device) LED type lamp essentially is made by bending a board into a box structure, so its shape is fixed and unchangeable, it is high in manufacturing cost and difficult to assemble. More particularly, the housing of this conventional SMD LED type lamp is difficult to be adjusted to fit the environment in which the lamp is to be installed. While making a new mould to fit the environment where the lamp is to be installed is uneconomical.

In addition, the light sources of the conventional SMD LED type lamp are installed in the housing of the lamp, and the light transmission cover is disposed at the opening of the housing, the light of the light sources is directly projected onto the light transmission cover, and finally projected out of the housing of the lamp after passing through the light transmission cover. To prevent poor illumination, the light sources on the SMD LED type lamp must be closely and densely disposed, which increases not only cost but power consumption as well. Especially, the closely and densely packed light sources have the problem of light overlapping, which will cause light spots, significantly affecting the illumination of the lamp.

The present invention has arisen to mitigate and/or obviate the afore-described disadvantages.

### SUMMARY OF THE INVENTION

The primary object of the present invention is to provide a low cost lamp structure which is flexible in shape, easy to assemble and produce better illumination without light spot.

A lamp structure in accordance with the present invention comprises: an aluminum extrusion pipe, a light transmission cover, and at least one light emitting member. The aluminum extrusion pipe is axially provided with at least one first sidewall, one second sidewall and one opening, the first sidewall is formed with at least one engaging groove in communication with a through hole defined in an inner surface of the first sidewall, the second sidewall is provided on a surface thereof facing the first sidewall and the opening with at least one light reflection surface. The light transmission cover is mounted on the aluminum extrusion pipe to cover the opening. The light emitting member includes a flexible circuit board and a plurality of light sources, the light sources are arranged spaced apart on a surface of the flexible circuit board facing the through hole, the light of the light sources of the light emitting member are focused on the light transmission cover through reflection by the light reflection surface, and finally projected out of the aluminum extrusion pipe after passing through the light transmission cover.

Since the aluminum extrusion pipe can be cut into any desired length and extruded into any shapes, such as arc shape, circular shape, wavy shape, and etc, the lamp structure of the present invention can be adjusted in size and shape to fit the environment in which it is to be installed. Furthermore, as compared with the conventional lamp, the lamp structure of the present invention is low in cost and easy to assemble. Especially, the light of the light sources is focused on the light transmission cover through reflection by the light reflection surfaces, and finally projected out of the aluminum extrusion pipe after passing through the light transmission cover, so that the problem of light spot can be prevented, and better illumination can be obtained with less number and density of the light sources of the light emitting member, considerably reducing manufacturing cost.

### BRIEF DESCRIPTION OF THE DRAWINGS

FIG. 1 is a cross sectional view of a lamp structure in accordance with a first embodiment of the present invention;

FIG. 2 shows another use condition of the lamp structure of the first embodiment, in which, two abovementioned lamp structures can be arranged side by side in a symmetrical manner'

FIG. 3 shows a lamp structure in accordance with a second embodiment of the present invention;

FIG. 4 is an exploded view of a straight aluminum extrusion pipe of the lamp structure in accordance with the present invention;

FIG. 5 is an assembly view of the straight aluminum extrusion pipe of the lamp structure in accordance with the present invention;

FIG. 6 is an assembly view of an arc-shaped aluminum extrusion pipe of the lamp structure in accordance with the present invention;

FIG. 7 is an exploded view of a circular aluminum extrusion pipe of the lamp structure in accordance with the present invention;

FIG. 8 is a cross sectional view of the circular aluminum extrusion pipe of the lamp structure in accordance with the present invention;

FIG. 9 is a cross sectional view of the light reflection surface of the lamp structure in accordance with a second embodiment of the present invention;

FIG. 10 is a cross sectional view of the light reflection surface of the lamp structure in accordance with a third embodiment of the present invention; and

FIG. 11 is a cross sectional view of the light reflection surface of the lamp structure in accordance with a fourth embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

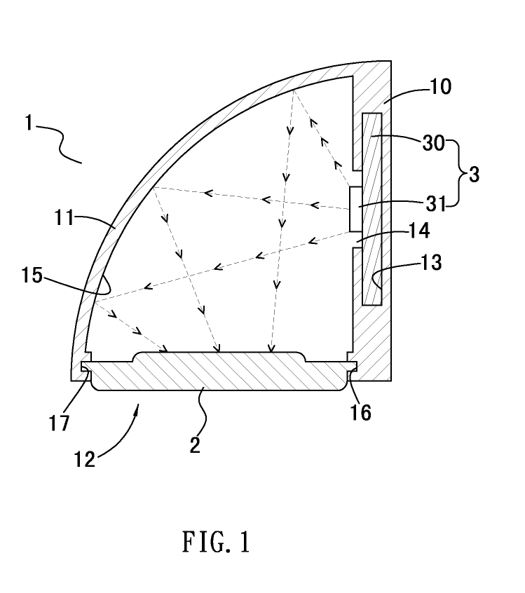

FIG. 1 shows a lamp structure in accordance with a first embodiment of the present invention, the lamp structure comprises: an aluminum extrusion pipe 1, a light transmission cover 2 and a light emitting member 3.

The aluminum extrusion pipe 1 is an elongated structure and axially provided with a first sidewall 10, a second sidewall 11 and an opening 12. The first sidewall 10 is a vertical structure formed with an engaging groove 13 which is in communication with a through hole 14 defined in an inner surface of the first sidewall 10. The second sidewall 11 is an arc-shaped structure extending from the top end of the first sidewall 10. The opening 12 is defined between the first and second sidewalls 10, 11 and located at the lower side of the aluminum extrusion pipe 1. The second sidewall 11 is provided on a surface thereof facing the first sidewall 10 and the opening 12 with a light reflection surface 15. The first and second sidewalls 10, 11 are formed in their opposite surfaces close to the opening 12 with a first groove 16 and a second groove 17, respectively.

The light transmission cover 2 has two sides engaged in the first and second grooves 16, 17 to cover the opening 12.

The light emitting member 3 includes a flexible circuit board 30 and a plurality of light sources 31. The flexible circuit board 30 is inserted in the engaging groove 13, the light sources 31 are arranged spaced apart on the flexible circuit board 30 and located in the through hole 14 to reflect light onto the light reflection surface 15. The light emitting member 3 in this embodiment can be SMD LED light, the light sources 31 are light emitting diodes. On the flexible circuit board 30 is provided with a starter (not shown) for starting the LEDs of the light emitting member 3.

The light of the light sources 31 of the light emitting member 3 is focused on the light transmission cover 2 through reflection by the light reflection surface 15, and finally projected out of the aluminum extrusion pipe 1 after passing through the light transmission cover 2, thus producing a lighting effect.

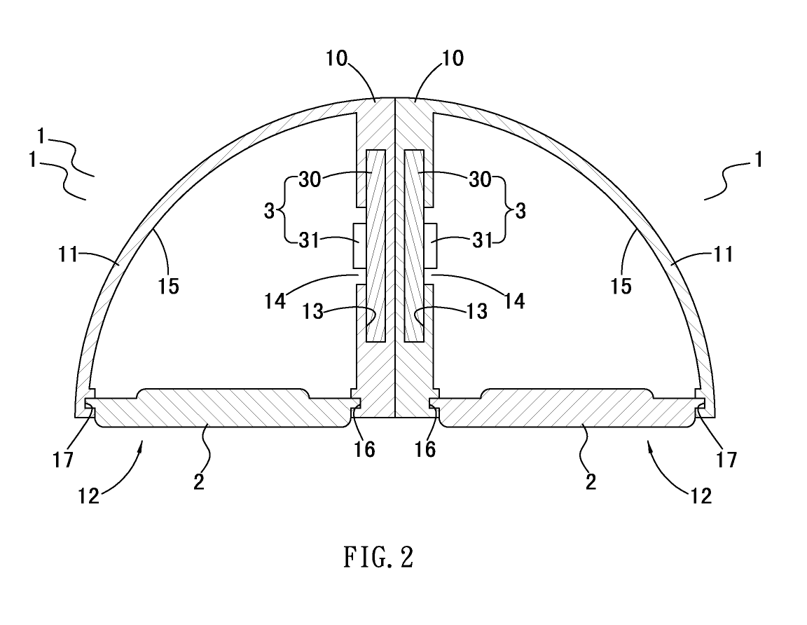

FIG. 2 shows another use condition of the lamp structure of the first embodiment, in which, two abovementioned lamp structures can be arranged side by side in a symmetrical manner.

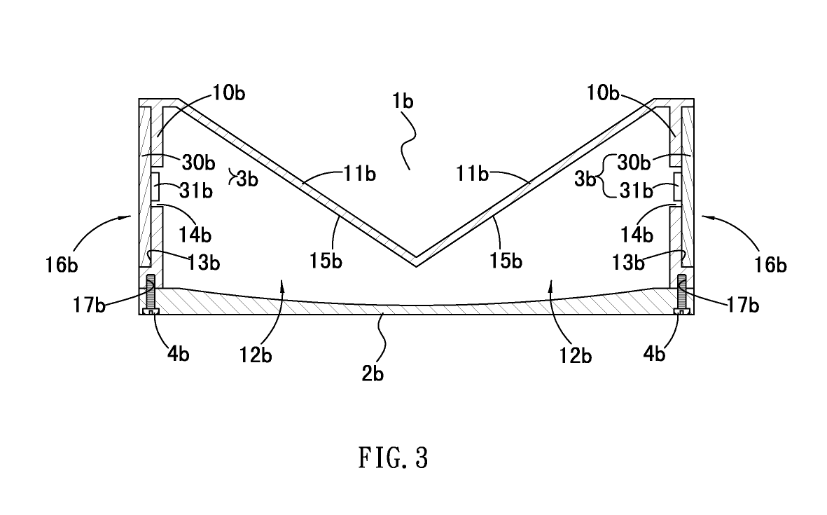

FIG. 3 shows a lamp structure in accordance with a second embodiment of the present invention, wherein the aluminum extrusion pipe 1b is an elongated structure and axially provided with two sidewalls 10b, two second sidewalls 11b and two openings 12b.

The first two sidewalls 10b are vertically arranged in parallel to each other. Each of the first sidewalls 10b is formed with an engaging groove 13b for accommodation of a flexible circuit board 30b of a light emitting member 3b. In an inner surface of the respective first sidewalls 10b is formed a through hole 14b which is in communication with the engaging groove 13b and provided for accommodation of the light sources 31b of the light emitting member 3b. In an outer surface of the respective first sidewalls 10b is formed an inserting hole 16b in communication with the corresponding engaging groove 13b, so that the light emitting member 3b can be placed in the engaging groove 13b via the inserting hole 16b. In a bottom edge of the respective first sidewalls 10b are formed a plurality of threaded holes 17b in which a plurality of screws 4b can be screwed, so that the light transmission cover 2b can be fixed to the aluminum extrusion pipe 1b to cover the two openings 12b.

The two second sidewalls 11b extend downward toward each other from the top edges of the two first sidewalls 10b and meet in the center between the two second sidewalls 11b, defining the two openings 12b at the lower part between the two second sidewalls 11b. Each of the two second sidewalls 11b is provided on a surface thereof facing the first sidewalls 10b with an oblique light reflection surface 15b.

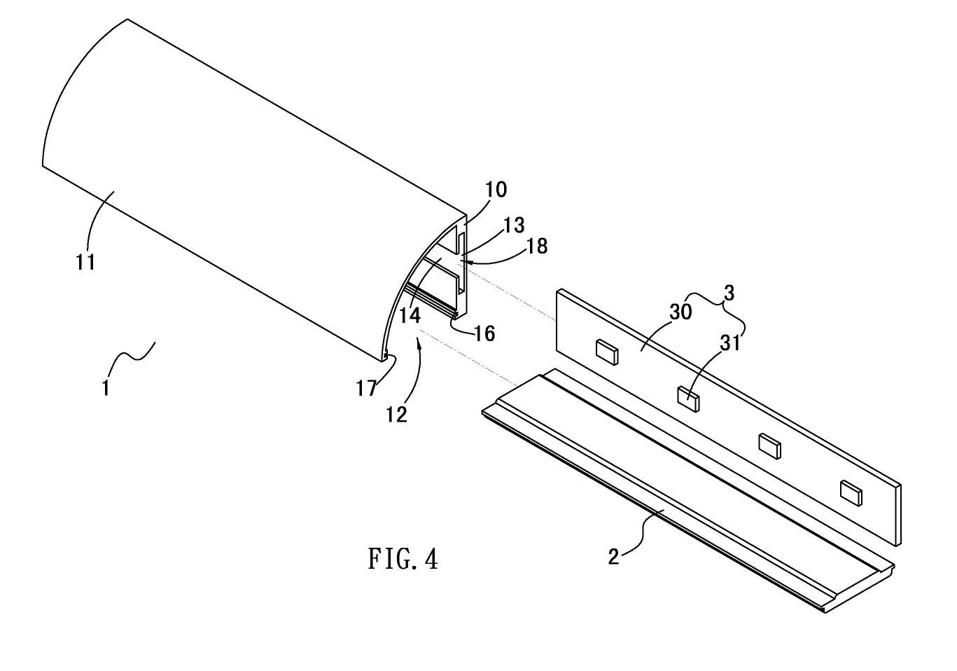

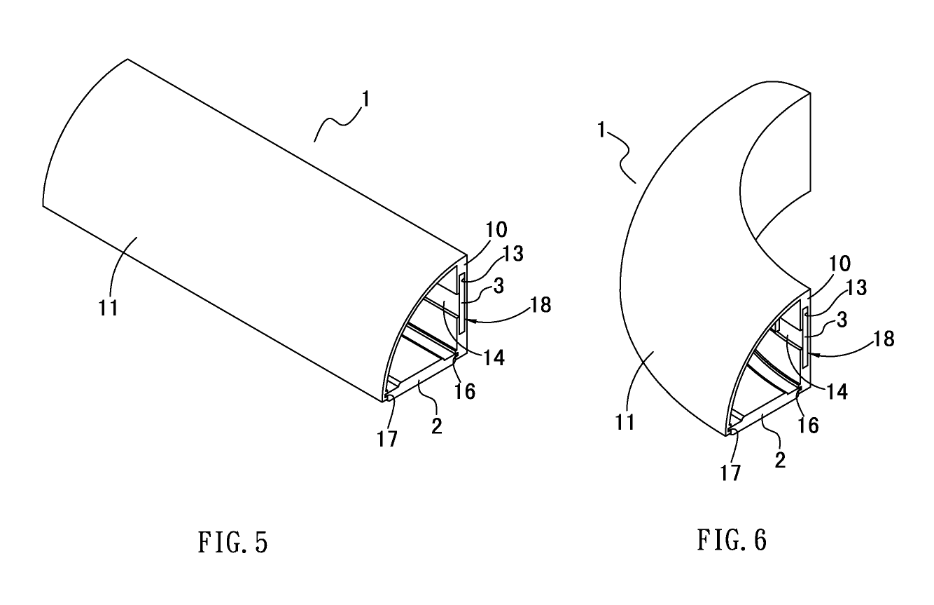

Referring to FIGS. 4-7, which show that the aluminum extrusion pipe 1 can be cut into any desired length and extruded into any shapes, such as arc shape, circular shape, wavy shape, and etc. Hence, the lamp structure of the present invention can be adjusted in size and shape to fit the environment in which it is to be installed. Furthermore, the lamp structure of the present invention is low in cost and easy to assemble.

Referring to FIGS. 4-6, one end of the sidewall 10 is formed with an inserting hole 18 in communication with the engaging groove 13, so that the light emitting member 3 can be inserted through the inserting hole 13 into the engaging groove 13. Each of the first and second grooves 16, 17 is open at one end thereof for insertion of the light transmission cover 2.

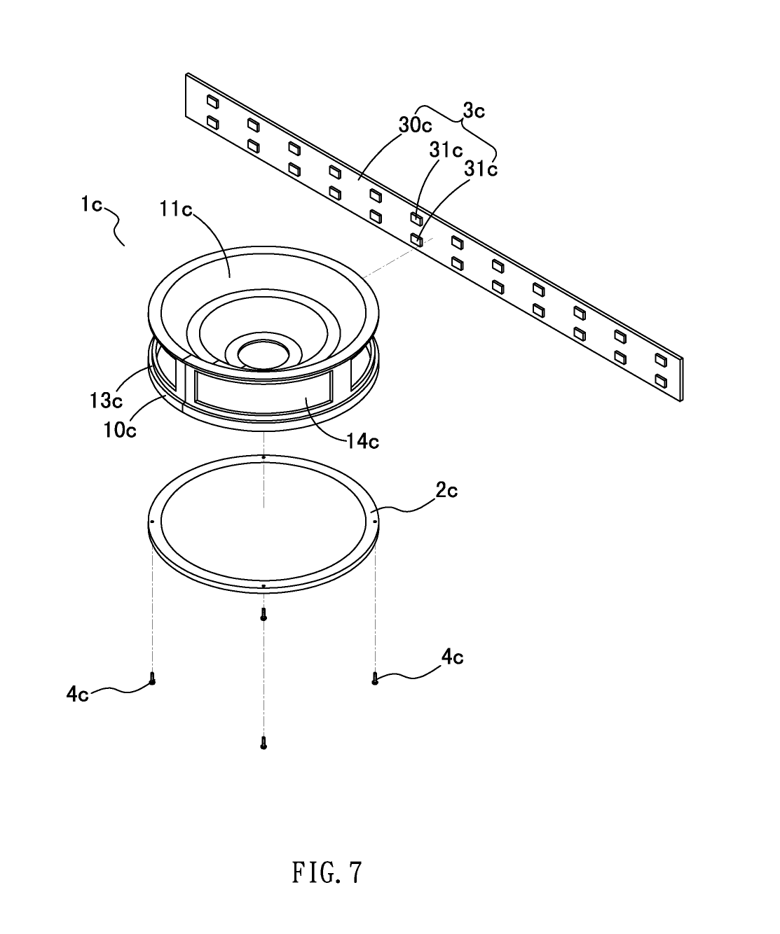

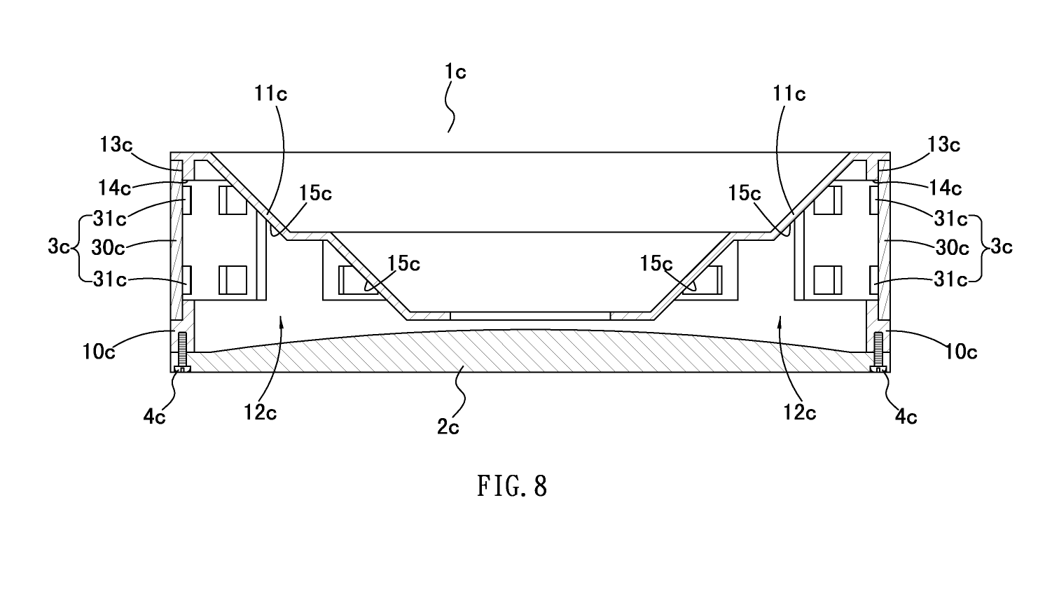

Referring to FIGS. 7 and 8, a lamp structure in accordance with another embodiment of the present invention comprises: an aluminum extrusion pipe 1c, a light transmission cover 2c, and a light emitting member 3c.

The aluminum extrusion pipe 1c is a circular structure which is provided around its outer periphery with a first sidewall 10c and provided around its inner periphery with a second sidewall 11c and is further formed with an opening 12c at the bottom thereof. In an outer surface of the first sidewall 10c is formed an engaging groove 13c, and in an inner surface of the first sidewall 10c are formed four through holes 14c in communication with the engaging groove 13c. The second sidewall 11c is a stepped structure extending obliquely downward toward the center of the aluminum extrusion pipe 1c. The second sidewall 11c is provided with two oblique light reflection surfaces 15c at the upper and lower portions thereof facing the first sidewall 10c and the opening 12c.

The light transmission cover 2c is fixed to the bottom of the first sidewall 10c by a plurality of screws 4c and covers the opening 12c.

The light emitting member 3c includes a flexible circuit board 30c and a plurality of light sources 31c. The flexible circuit board 30c can be bent and engaged in the engaging groove 13c. The light sources 31c are located spaced apart on the flexible circuit board 30c and arranged in two upper and lower rows. The light sources 31c are located in the through holes 14c. The light of the light sources 31c is focused on the light transmission cover 2c through reflection by the light reflection surfaces 15c, and finally projected out of the aluminum extrusion pipe 1c after passing through the light transmission cover 2c.

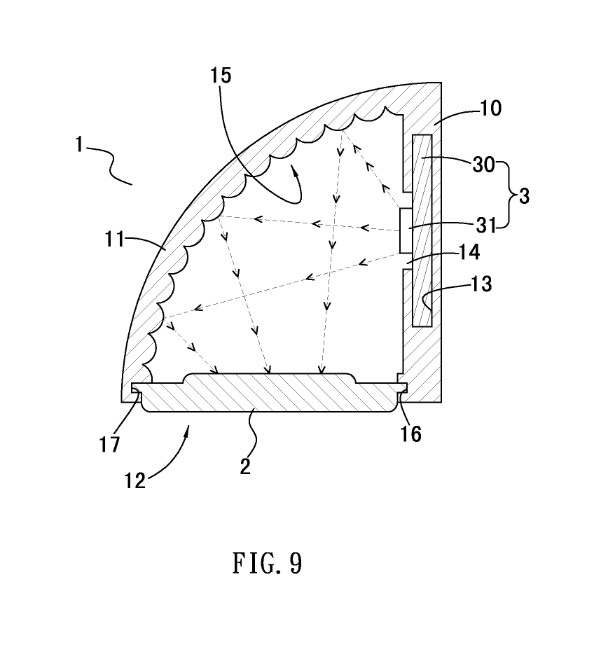

Referring to FIG. 9, which shows that the reflection surfaces 15, 15a, 15b, and 15c (not shown) of the abovementioned embodiments can be an uneven structure consisting of a plurality of convex arc-shaped surfaces.

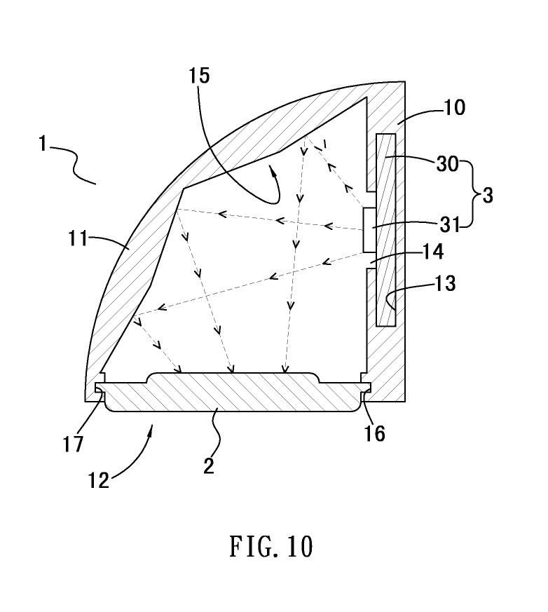

Referring to FIG. 10, which shows that the reflection surfaces 15, 15a, 15b, and 15c (not shown) of the abovementioned embodiments can be an uneven structure consisting of a plurality of oblique surfaces.

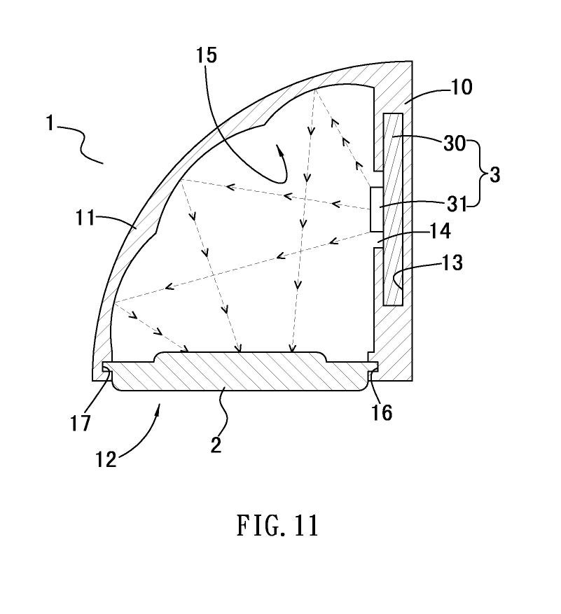

Referring then to FIG. 11, which shows that the reflection surfaces 15, 15a, 15b, and 15c (not shown) of the abovementioned embodiments can be an uneven structure consisting of a plurality of concave arc-shaped surfaces.

FIGS. 1 and 9-11 show that the light of the light sources 31 is focused on the light transmission cover 2 through reflection by the light reflection surfaces 15, and finally projected out of the aluminum extrusion pipe 1 after passing through the light transmission cover 2, so that the problem of light spot can be prevented, and better illumination can be obtained with less number and density of the light sources 31 of the light emitting member 3, considerably reducing manufacturing cost.

While we have shown and described various embodiments in accordance with the present invention, it is clear to those skilled in the art that further embodiments may be made without departing from the scope of the present invention.

What is claimed is:

1. A lamp structure comprising:
an aluminum extrusion pipe axially provided with at least one first sidewall, one second sidewall and one opening, the first sidewall being formed with at least one engaging groove in communication with a through hole defined in an inner surface of the first sidewall, the second sidewall being provided on a surface thereof facing the first sidewall and the opening with at least one light reflection surface;
a light transmission cover mounted on the aluminum extrusion pipe to cover the opening; and
at least one light emitting member including a flexible circuit board and a plurality of light sources, the light sources being arranged spaced apart on a surface of the flexible circuit board facing the through hole, the light of the light sources of the light emitting member being focused on the light transmission cover through reflection by the light reflection surface, and finally projected out of the aluminum extrusion pipe after passing through the light transmission cover.

2. The lamp structure as claimed in claim 1, wherein the light emitting member is surface mount device type of light, and the light sources are light emitting diodes.

3. The lamp structure as claimed in claim 2, wherein at least one inserting hole is formed in one end of the respective first sidewall and is in communication with the corresponding engaging groove, so that the light emitting member can be inserted in the engaging groove via the inserting hole.

4. The lamp structure as claimed in claim 2, wherein at least one inserting hole is formed in an outer surface of the respective first sidewall and is in communication with the corresponding engaging groove, so that the light emitting member can be inserted in the engaging groove via the inserting hole.

5. The lamp structure as claimed in claim 2, wherein the aluminum extrusion pipe axially provided with two first sidewalls and two second sidewalls, the first two sidewalls are vertically arranged in parallel to each other, each of the first sidewalls is formed with an engaging groove for accommodation of a flexible circuit board of a light emitting member, in an inner surface of the respective first sidewalls is formed a through hole which is in communication with the engaging groove and provided for accommodation of the light sources of the light emitting member, the two second sidewalls extend downward toward each other from the top edges of the two first sidewalls and meet in the center between the two second sidewalls, defining two openings at a lower part between the two second sidewalls, each of the two second sidewalls is provided on a surface thereof facing the first sidewalls with at least one light reflection surface, and the cover covers the two openings.

6. The lamp structure as claimed in claim 2, wherein the aluminum extrusion pipe is a circular structure.

7. The lamp structure as claimed in claim 4, wherein the aluminum extrusion pipe is a circular structure.

8. The lamp structure as claimed in claim 2, wherein the light reflection surface is arc-shaped.

9. The lamp structure as claimed in claim 4, wherein the light reflection surface is arc-shaped.

10. The lamp structure as claimed in claim 2, wherein the light reflection surface is an uneven structure consisting of a plurality of convex surfaces and concave surfaces.

11. The lamp structure as claimed in claim 4, wherein the light reflection surface is an uneven structure consisting of a plurality of convex surfaces and concave surfaces.

12. The lamp structure as claimed in claim 2, wherein the light reflection surface is an uneven structure consisting of a plurality of convex surfaces.

13. The lamp structure as claimed in claim 4, wherein the light reflection surface is an uneven structure consisting of a plurality of convex surfaces.

14. The lamp structure as claimed in claim 2, wherein the light reflection surface is an uneven structure consisting of a plurality of concave surfaces.

15. The lamp structure as claimed in claim 4, wherein the light reflection surface is an uneven structure consisting of a plurality of concave surfaces.
